(19) United States
(12) Patent Application Publication
(10) Pub. No.: US 2020/0173490 A1
(43) Pub. Date: Jun. 4, 2020

(54) SUPPORTING STRUCTURE FOR ROTARY SHAFT

(71) Applicant: TOYOTA JIDOSHA KABUSHIKI KAISHA, Aichi (JP)

(72) Inventors: Masashi SHINODA, Shizuoka-ken (JP); Akiko NISHIMINE, Susono-shi (JP); Shotaro KATO, Shizuoka-ken (JP); Kensei HATA, Shizuoka-ken (JP); So OKITA, Susono-shi (JP)

(21) Appl. No.: 16/699,111

(22) Filed: Nov. 29, 2019

(30) Foreign Application Priority Data
Nov. 30, 2018 (JP) 2018-224410

(51) Int. Cl. F16C 19/08

(52) U.S. Cl. CPC F16C 19/08; F16C 2380/26

(57) ABSTRACT

A shaft supporting structure in which a shaft support span is reduced to prevent flexure of the shaft. In the supporting structure, a rotary member is mounted on a rotary shaft supported by bearings to be rotated integrally therewith, and the bearings are supported by a support member. The first bearing and the second bearing are disposed on both sides of the rotary member on the rotary shaft, and the first bearing is disposed between the rotary member and the fastening member in the axial direction of the rotary shaft.

### CROSS REFERENCE TO RELATED APPLICATIONS

The present application claims the benefit of priority to Japanese Patent Application No. 2018-224410 filed on Nov. 30, 2018 with the Japanese Patent Office, the entire contents of which are incorporated herein by reference in its entirety.

### BACKGROUND

### Field of the Disclosure

Embodiments of the disclosure relate to the art of a supporting structure to support a rotary shaft on which a predetermined rotary member is mounted such as a rotor shaft of a motor or a rotary shaft of a gear through a bearing.

### Discussion of the Related Art

JP-A-2017-77148 describes a vehicular motor that can prevent an occurrence of electric corrosion of a bearing and that can reduce fuel consumption. The motor taught by JP-A-2017-77148 comprises: a hollow rotor shaft that supports an intermediate portion of a rotor core in a longitudinal direction; support members such as a main case and a rear cover that support both ends of the rotor shaft through a bearing respectively; and a fixed shaft member in which one end is supported by the support member and other end is inserted into the rotor shaft. The other end of the fixed shaft member projects outwardly from an end portion of the rotor core without being contacted electrically to the rotor shaft.

According to the teachings of JP-A-2017-77148, a flange is formed around an outer peripheral surface of one end of the rotor shaft, and a nut is screwed onto a male thread formed on the outer peripheral surface of the other end of the rotor shaft to fix the rotor to the rotor shaft. In the motor taught by JP-A-2017-77148, a rotor core is interposed between the flange and the nut. One end of the rotor shaft is supported by the main case through the bearing, and the other end is supported e.g., by the rear cover through the bearing. Turning to FIG. 1, there is schematically shown a structure of the conventional motor taught e.g., by JP-A-2017-77148. As shown in FIG. 1, in a motor 100, a male thread 102 is formed on one end of a rotor shaft 101, and a nut 105 is screwed onto said one end of the rotor shaft 101 to fix a rotor core 104 of a rotor 103 on the rotor shaft 101. A bearing 106 is fitted onto a leading end of the rotor shaft 101 which is axially outer side of the nut 105 so that the rotor shaft 101 is supported to a main body 107 through the bearing 106. In the motor taught by JP-A-2017-77148, each leading end of the rotor shaft is rotatably supported through the bearing, and hence a distance between the bearings, that is, a support span is relatively long. Therefore, the rotor shaft may be subjected to a relatively large a bending moment.

In addition, in the conventional motor 100 shown in FIG. 1, an air gap 109 is maintained between an inner peripheral surface of a stator 108 and an outer peripheral surface of the rotor 103. Basically, a density of magnetic flux may be increased to enhance a performance of the motor by reducing the air gap. To this end, in an inner rotor motor, it is preferable to reduce the air gap as much as possible. However, if the support span of the rotor shaft is too long, the air gap in the motor is narrowed by a deformation of the rotor shaft thereby causing an interference between the inner peripheral surface of the stator and the outer peripheral surface of the rotor.

### SUMMARY

Aspects of embodiments of the present disclosure have been conceived noting the foregoing technical problems, and it is therefore an object of the present disclosure to provide a shaft supporting structure in which a shaft support span is reduced to prevent flexure of the shaft.

According to the exemplary embodiment of the present disclosure, there is provided a supporting structure for a rotary shaft, comprising: a rotary member that is mounted on the rotary shaft to be rotated integrally with the rotary shaft; a fastening member that fastens the rotary member on the rotary shaft; a first bearing and a second bearing that support the rotary shaft in a rotatable manner; and a support member that supports the rotary shaft through the first bearing and the second bearing. According to the exemplary embodiment of the present disclosure, the first bearing and the second bearing are disposed on both sides of the rotary member on the rotary shaft in an axial direction of the rotary shaft. In addition, the first bearing is disposed between the rotary member and the fastening member in the axial direction of the rotary shaft, and is fastened on the rotary shaft together with the rotary member by the fastening member.

In a non-limiting embodiment, the rotary member may include a rotor of an inner rotor type motor, and the rotary shaft may include a rotor shaft of the motor. The first bearing and the second bearing may be disposed on both sides of the rotor on the rotor shaft in an axial direction of the rotary shaft.

In a non-limiting embodiment, the rotor shaft may be formed integrally with another rotary shaft on which another rotary member other than the rotor is mounted.

In a non-limiting embodiment, the rotor shaft may be joined to another rotary shaft on which another rotary member other than the rotor is mounted.

Thus, according to the exemplary embodiment of the present disclosure, the first bearing is fastened on the rotary shaft together with the rotary member by the fastening member. For example, given that a nut is adopted as the fastening member, the first bearing is fastened on the rotary shaft while being brought into abutment on the rotary member by screwing the nut onto the rotary shaft. According to the embodiment of the present disclosure, therefore, a distance between the first bearing and the second bearing, that is, a support span of the rotary shaft in the axial direction can be shortened compared to the conventional structure in which the bearing is disposed axially outer side of the nut. For this reason, a bending moment applied to the rotary shaft can be reduced to prevent flexure of the rotary shaft.

According to the embodiment of the present disclosure, specifically, a support span of the rotor shaft on which the rotor of the motor is mounted can be shortened. Therefore, a bending moment applied to the rotor shaft can be reduced to prevent flexure of the rotor shaft. In addition, an interference between the rotor and a stator can be prevented to maintain an air gap of the motor.

According to the embodiment of the present disclosure, for example, the rotor shaft of the motor on which the rotor is mounted may be formed integrally with another shaft on which another rotary member such as a gear is mounted. In this case, number of parts can be reduced to reduce a manufacturing cost of the supporting structure.

According to the embodiment of the present disclosure, the rotor shaft of the motor may also be formed separately from another shaft on which e.g., the gear is mounted. Therefore, the support span of the rotor shaft can be shortened compared to a case of forming the rotor shaft integrally with another shaft. For this reason, a bending moment applied to the rotor shaft can be reduced to prevent flexure of the rotor shaft. In addition, an interference between the rotor and the stator can be prevented to maintain the air gap of the motor.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a partial cross-sectional view showing one example of the conventional supporting structure to support the rotor shaft of the motor;

FIG. 2 is a cross-sectional view showing a first example of the supporting structure in which a rotor shaft and a gear shaft are integrated to form a rotary shaft, and the rotary shaft is supported at both ends;

FIG. 3 is a partial cross-sectional view showing a structure to fasten a rotor and a bearing by a nut in the supporting structure shown in FIG. 2 in an enlarged scale;

FIG. 4 is a cross-sectional view showing a second example of the supporting structure in which the rotor shaft and the gear shaft are integrated to form the rotary shaft, and the rotary shaft is supported at three points; and

FIG. 5 a cross-sectional view showing a third example of the supporting structure in which the rotor shaft and the gear shaft are joined to each other to form the rotary shaft.

### DETAILED DESCRIPTION OF THE PREFERRED EMBODIMENT(S)

Preferred embodiments of the present disclosure will now be explained with reference to the accompanying drawings.

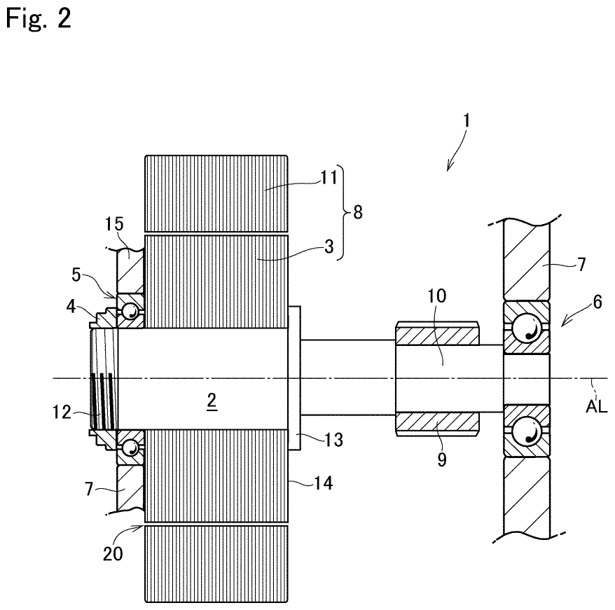

Turning now to FIG. 2, there is shown the first example of a supporting structure 1 according to the embodiment of the present disclosure. The supporting structure 1 illustrated in FIG. 2 comprises a rotor shaft 2, a rotor 3, a nut 4, a bearing 5, a bearing 6, and a case 7.

Specifically, the rotor shaft 2 is a rotary shaft of a motor 8, and a rotor 3 of the motor 8 is fitted onto the rotor shaft 2. The rotor shaft 2 may be formed integrally with another rotary shaft on which another rotary member such as a gear is mounted. According to the first example, specifically, the rotor shaft 2 is formed integrally with a gear shaft 10 on which a gear 9 is mounted.

The rotor 3 is rotated integrally with the rotor shaft 2 to serve as a rotary member of the embodiment of the present disclosure. Specifically, the motor 8 is an inner rotor type motor comprising the rotor shaft 2, the rotor 3, and a stator 11. For example, the motor 8 is used as a prime mover of automobiles to generate torque by supplying electricity thereto. To this end, for example, a permanent magnet synchronous motor and an induction motor may be adopted as the motor 8. When the motor 8 is rotated passively by a torque applied thereto, the motor 8 may also serve as a generator to generate electricity. That is, the motor 8 may be a motor-generator that serves not only as a motor but also as a generator.

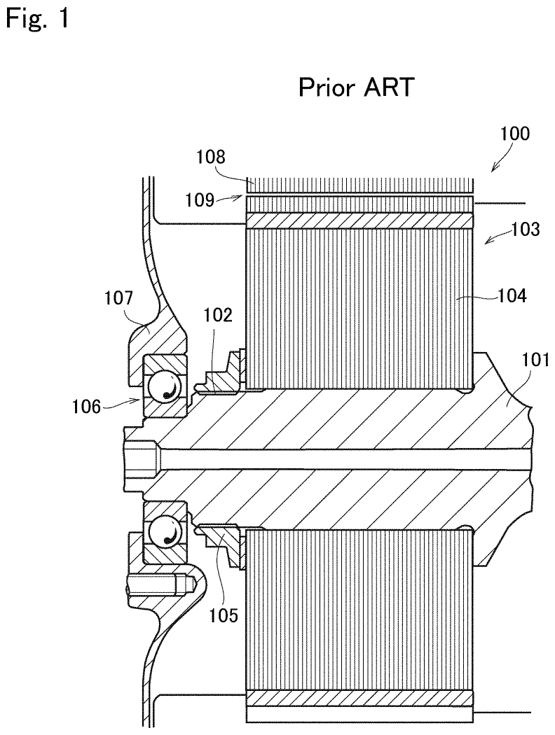

The rotor 3 is fastened on the rotor shaft 2 by screwing the nut 4 onto a male thread 12 formed on one end (i.e., a left end in FIG. 1) of the rotor shaft 2. Accordingly, the nut 4 serves as a fastening member of the embodiment of the present disclosure. In order to restrict displacement of the rotor 3 in an axial direction AL, a flange 13 is formed around the rotor shaft 2 at a portion to be brought into contact to one of end faces (i.e., a right end face in FIG. 1) 14 of the rotor 3. As described, a fastening force of the nut 4 is applied to the other end face (i.e., a left end face in FIG. 1) 15 of the rotor 3 so that the rotor 3 is clamped between the nut 4 and the flange 13 to be fixed on the rotor shaft 2.

The rotor shaft 2 is supported by the bearings 5 and 6 at both ends in the axial direction AL in a rotatable manner. According to the first example shown in FIG. 2, specifically, the bearing 5 is fitted onto one end (i.e., a left end in FIG. 1) of the rotor shaft 2 at left side of the rotor 3. On the other hand, the bearing 6 is fitted onto one end (i.e., a right end in FIG. 1) of the gear shaft 10 formed integrally with the rotor shaft 2. Both of the bearings 5 and 6 are supported by the case 7 as a supporting member of the embodiment of the present disclosure. Thus, according to the first example shown in FIG. 2, the rotor shaft 2 of the motor 8 is supported at two points by the case 7.

Specifically, the bearing 5 is interposed between the nut 4 and the rotor 3 so that the bearing 5 and the rotor 3 are fastened on the rotor shaft 2. Accordingly, the bearing 5 serves as a first bearing of the embodiment of the present disclosure, and the bearing 6 serves as a second bearing of the embodiment of the present disclosure.

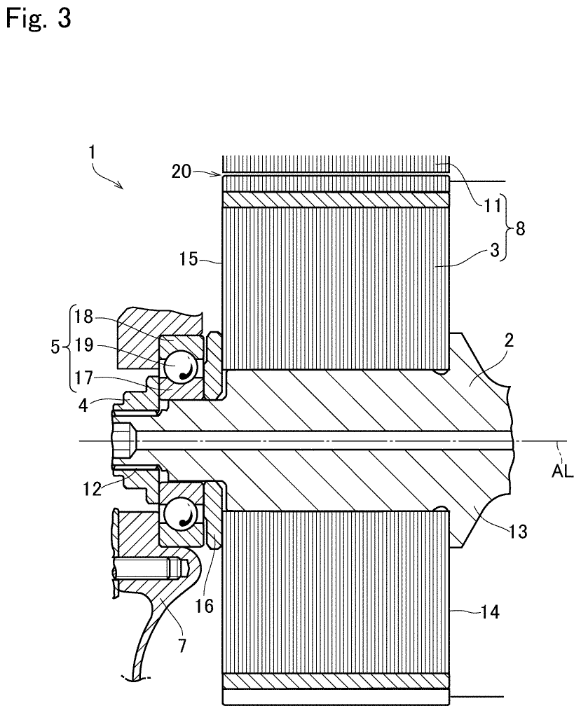

The structure to fasten the rotor 3 on the rotor shaft 2 is illustrated in more detail in FIG. 3. As illustrated in FIG. 3, the end face 14 of the rotor 3 is brought into abutment on the flange 13 of the rotor shaft 2, and the bearing 5 is fitted onto said one end of the rotor shaft 2. In addition, an annular retainer 16 is interposed between the end face 15 of the rotor 3 and the bearing 5. In the first example, a radial bearing is adopted as the bearing 5, and the bearing 5 comprises an inner race 17, an outer race 18, a ball 19, and a retainer (not shown) holding the ball 19. Specifically, the inner race 17 is fitted onto said one end of the rotor shaft 2, and the outer race 18 is fixed to the case 7. Although not especially illustrated in FIG. 3, the radial bearing is also adopted as the bearing 6, and an inner race (not shown) of the bearing 6 is fitted onto said one end of the gear shaft 10 and an outer race (not shown) of the bearing 6 is fixed to the case 7.

The nut 4 is screwed onto said one end of the rotor shaft 2 (i.e., a left end in FIG. 3) from an axially outer side of the bearing 5 so that the bearing 5 and the rotor 3 are fastened on the rotor shaft 2 by a fastening force of the nut 4.

Thus, in the supporting structure 1 according to the first example, the rotor shaft 2 is supported at two points by the bearings 5 and 6, and one of the bearings 5 is fastened by the nut 4 from axially outer side to be brought into abutment on the rotor 3. According to the first example, therefore, a distance between the bearing 5 and the bearing 6, that is, a support span of the rotor shaft 2 can be shortened compared to the conventional structure as shown e.g., in FIG. 1 in which the bearing 106 is disposed axially outer side of the nut 105. For this reason, a bending moment applied to the rotor shaft 2 can be reduced to prevent flexure of the rotor shaft 2. In addition, an interference between the rotor 3 and the stator 11 can be prevented to maintain an air gap 20 of the motor 8.

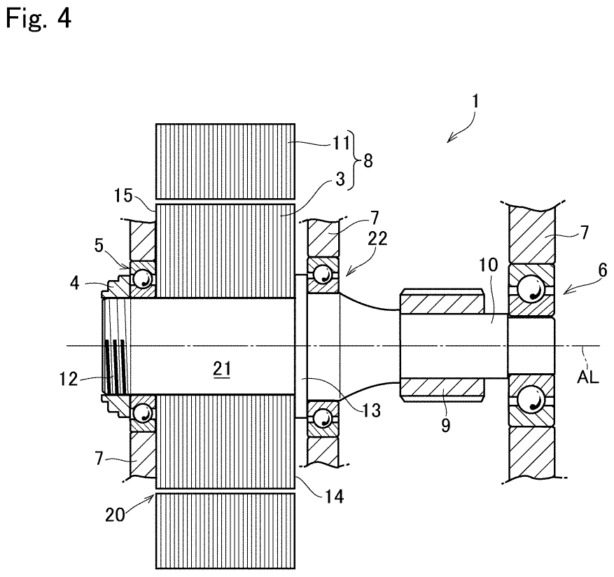

Turning to FIG. 4, there is shown the second example of the supporting structure 1 in which the rotary shaft is supported at three points. In the second example shown in FIG. 4, common reference numerals are allotted to the elements in common with those of the first example shown in FIGS. 2 and 3.

According to the second example shown in FIG. 4, a rotor shaft 21 of the motor 8 serves as the rotary shaft of the embodiment of the present disclosure, and the rotor shaft 21 is also formed integrally with the gear shaft 10 on which the gear 9 is mounted. As illustrated in FIG. 4, the rotor shaft 21 is supported by the bearings 5 and 6, and a bearing 22.

In order to further support the rotor shaft 21 in a rotatable manner, the bearing 22 is fitted onto the rotor shaft 21 on an opposite side of the bearing 5 across the rotor 3. Specifically, the bearing 22 is fitted onto the rotor shaft 21 at a portion to be brought into abutment on one of end faces (i.e., a right end face in FIG. 4) of the flange 13, and the end face 14 of the rotor 3 is brought into abutment on the other end face (i.e., a left end face in FIG. 4) of the flange 13. The bearing 22 is also supported by the case 7. In the second example, accordingly, the bearing 22 also serves as the second bearing of the embodiment of the present disclosure. That is, according to the embodiment of the present disclosure, the second bearing may include a plurality of bearings.

Thus, in the supporting structure 1 according to the second example, the rotor shaft 21 is supported at three points by the bearings 5, 6, and 22. According to the second example, therefore, the support span of the rotor shaft 21 can be further shortened compared to a case of supporting the rotor shaft 21 at two points. For this reason, a bending moment applied to the rotor shaft 21 can be reduced to prevent flexure of the rotor shaft 21. In addition, since the rotor shaft 21 is formed integrally with the gear shaft 10 as the foregoing rotor shaft 2, number of parts can be reduced to reduce a manufacturing cost of the supporting structure 1.

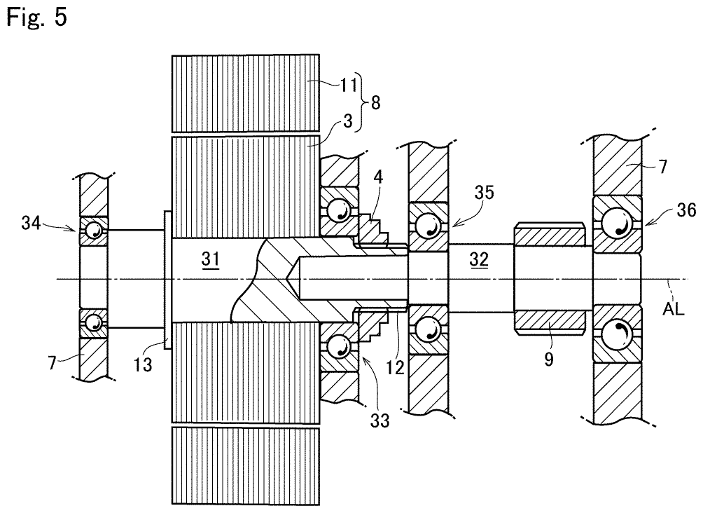

Turning to FIG. 5, there is shown the third example of the supporting structure 1 in which the rotary shaft is joined to another shaft. In the third example shown in FIG. 5, common reference numerals are also allotted to the elements in common with those of the first example shown in FIGS. 2 and 3.

According to the third example shown in FIG. 5, a rotor shaft 31 as a rotary shaft of the motor 8 is joined to a gear shaft 32 on which the gear 9 is mounted to be rotated integrally therewith. The rotor shaft 31 is supported by a bearing 33 and a bearing 34 in a rotatable manner, and the gear shaft 32 is supported by a bearing 35 and a bearing 36 in a rotatable manner. Those bearings 33, 34, 35, and 36 are also supported by the case 7.

Specifically, the bearing 33 serving as the first bearing is fitted onto a joining end of the rotor shaft 31 to be brought into abutment on one of end faces of the rotor 3, and the nut 4 is screwed onto the joining end of the rotor shaft 31 from a tip of the joining end. That is, the bearing 33 is fastened together with the rotor 3 on the rotor shaft 31 by a fastening force of the bearing 33 to support the rotor shaft 31 in a rotatable manner. On the other hand, the bearing 34 serving as the second bearing is fitted onto the rotor shaft 31 at an opposite side (i.e., a left side in FIG. 5) to the bearing 33.

Thus, according to the third example shown in FIG. 5, the rotor shaft 31 is joined to the gear shaft 32 formed separately. According to the third example, therefore, the support span of the rotor shaft 31 can be shortened compared to a case of forming the rotor shaft 31 integrally with the gear shaft 32. For this reason, a bending moment applied to the rotor shaft 31 can be reduced to prevent flexure of the rotor shaft 31. In addition, an interference between the rotor 3 and the stator 11 can be prevented to maintain the air gap 20 of the motor 8.

Although the above exemplary embodiments of the present disclosure have been described, it will be understood by those skilled in the art that the present disclosure should not be limited to the described exemplary embodiments, and various changes and modifications can be made within the scope of the present disclosure. For example, the supporting structure 1 according to the embodiment of the present disclosure may also be applied to another kind of machinery to support a rotary shaft on which a gear or a pulley is mounted.

What is claimed is:

1. A supporting structure for a rotary shaft, comprising:
a rotary member that is mounted on the rotary shaft to be rotated integrally with the rotary shaft;
a fastening member that fastens the rotary member on the rotary shaft;
a first bearing and a second bearing that support the rotary shaft in a rotatable manner; and
a support member that supports the rotary shaft through the first bearing and the second bearing;
wherein the first bearing and the second bearing are disposed on both sides of the rotary member on the rotary shaft in an axial direction of the rotary shaft, and
the first bearing is disposed between the rotary member and the fastening member in the axial direction of the rotary shaft, and is fastened on the rotary shaft together with the rotary member by the fastening member.

2. The supporting structure for the rotary shaft as claimed in claim 1,
wherein the rotary member includes a rotor of an inner rotor type motor,
the rotary shaft includes a rotor shaft of the motor, and
the first bearing and the second bearing are disposed on both sides of the rotor on the rotor shaft in an axial direction of the rotary shaft.

3. The supporting structure for the rotary shaft as claimed in claim 2, wherein the rotor shaft is formed integrally with another rotary shaft on which another rotary member other than the rotor is mounted.

4. The supporting structure for the rotary shaft as claimed in claim 2, wherein the rotor shaft is joined to another rotary shaft on which another rotary member other than the rotor is mounted.
